(19) United States
(12) Patent Application Publication
(10) Pub. No.: US 2016/0299750 A1
(43) Pub. Date: Oct. 13, 2016

(54) CUSTOMIZED AUTOMATED INSTALL PROCESS

(71) Applicant: Quantum Corporation, San Jose, CA (US)

(72) Inventors: John Koniges, Eagan, MN (US); Jeanette Obernolte, St. Paul, MN (US); Andrew Lewis, Minneapolis, MN (US); Neil Bannister, Chanhassen, MN (US); John Badger, Prior Lake, MN (US); Paal Olsen, Newton, MA (US); Rob Metcalf, St. Paul, MN (US)

(21) Appl. No.: 15/097,540

(22) Filed: Apr. 13, 2016

Related U.S. Application Data
(60) Provisional application No. 62/146,459, filed on Apr. 13, 2015.

(51) Int. Cl. G06F 9/445; G06Q 50/18; G06Q 30/06

(52) U.S. Cl. CPC G06F 8/61; G06Q 30/0633; G06Q 50/184

(57) ABSTRACT

Computerized methods and apparatus capture electronic information about a purchase of a combination of computer hardware and software. A registration associated with the purchase is detected as part of an installation of the computer hardware or software. A customized automated installation process that provides a graphical linear experience through the installation of the computer hardware or software is provided. The graphical linear experience is presented on computer hardware other than computer hardware included in the purchase. The graphical experience includes photographs or diagrams that are customized to the purchase based on the purchased items. The customized automated installation process runs, at least in a part, on a processor other than a processor included in the purchase. Step by step instructions that are customized for the combination of hardware and software are presented. Electrical connectivity, data connectivity, provisioning results, and other information are acquired during the installation.

### CROSS REFERENCE TO RELATED APPLICATIONS

This application claims the benefit of U.S. Provisional Application 62/146,459 filed Apr. 13, 2015.

### BACKGROUND

We are all familiar with the pain and frustration of installing new computer hardware and software. Some manufacturers make some effort to provide useful documentation and even online tech support, but other manufacturers seem to abandon their customers to their own fates. The amount of time wasted trying to install computer hardware and software continues to grow as more and more computers, peripherals, and applications are purchased.

Some computer hardware and software includes a user manual. Some user manuals include pictures and text. These manuals are static and generic. Since there are so many different types of computer hardware with a nearly infinite variety of configurations, these static presentations rarely contain information that is precisely tailored for any single individual customer or purchase. Instead, static manuals tend to provide generic information for a generic configuration. Also, these manuals tend to present many branch points where an installer has to flip ahead or flip back to get to their particular issue. Since computer hardware and software changes so quickly, and since users are constantly adding and removing applications, static manuals tend to become obsolete quickly.

Some computer hardware and software may come with a video or a link to an install video. Again, since there are so many possible computers with so many possible configurations, these video presentations also tend to contain information that applies to a general case or a generic configuration. Rarely, if ever, do these videos contain information that matches the exact configuration of any single individual customer or purchase.

Some computer hardware and software may even come with an install wizard. The install wizard tends to run on the device being installed or configured. Therefore, a baseline amount of functionality needs to be achieved for the hardware or software being installed before the wizard can run. This may be difficult to achieve, particularly when extensive cabling is required before baseline functionality is achieved. Since it is impossible to anticipate every possible configuration that the install wizard may encounter, only a finite number of configurations may be accounted for by the wizard. Additionally, the wizards tend to proceed in a branching fashion that goes through all the possible steps, making decisions at each step until reporting a success or failure. The problem space associated with debugging this type of multi-step multi-path installation is extremely large, which may produce serious challenges for both the installer and tech support.

These shortcomings with conventional installation procedures may produce inefficiencies that include wasted time and user frustration. Additionally, a sub-optimal installation may cause the installed hardware or software to perform in a sub-optimal way. Even if an installation appears to have completed successfully, the user may not become aware of an error until some later time, if ever, causing additional wasted time and continuing waste of resources.

### BRIEF DESCRIPTION OF THE DRAWINGS

Drawings found herein illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example data flow associated with providing a customized automated install process.

FIG. 2 illustrates an example method associated with providing a customized automated install process.

FIG. 3 illustrates an example apparatus associated with providing a customized automated install process.

FIG. 4 illustrates an example screen shot presented during a customized automated install process.

FIG. 5 illustrates an example screen shot presented during a customized automated install process.

FIG. 6 illustrates an example screen shot presented during a customized automated install process.

FIG. 7 illustrates an example screen shot presented during a customized automated install process.

FIG. 8 illustrates an example screen shot presented during a customized automated install process.

FIG. 9 illustrates an example screen shot presented during a customized automated install process.

FIG. 10 illustrates an example screen shot presented during a customized automated install process.

FIG. 11 illustrates an example screen shot presented during a customized automated install process.

FIG. 12 illustrates an example screen shot presented during a customized automated install process.

FIG. 13 illustrates an example screen shot presented during a customized automated install process.

FIG. 14 illustrates an example screen shot presented during a customized automated install process.

FIG. 15 illustrates an example screen shot presented during a customized automated install process.

FIG. 16 illustrates an example screen shot presented during a verification process.

FIG. 17 is a flow diagram of one embodiment of example methods associated with providing a customized automated install process.

### DETAILED DESCRIPTION

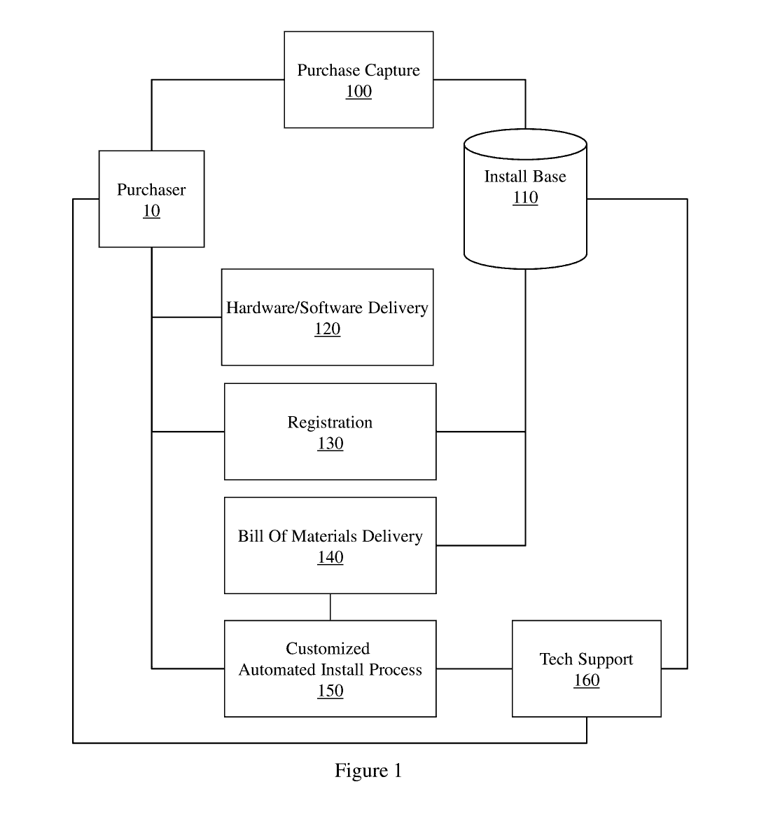

FIG. 1 illustrates an example data flow associated with providing a customized automated install process. A purchaser 10 makes a purchase of computer hardware or software. The details of the purchase are captured at purchase capture 100. The purchase capture 100 may occur at a point of sale device, at a trusted vendor apparatus that has adequate computer security installed, at a server accessed during the purchase, at a website accessed during the purchase, or at other secure locations. The purchase capture 100 may produce an electronic record that includes information that identifies the computer hardware or software. The details of the purchase may be provided securely to the vendor. For example, the details of the purchase may be provided through a secure link to a location inside the vendor's firewall, or may be made available at a data storage location from which the vendor can retrieve data. The details may include identifiers of the computer hardware and software purchased, an activation date, an activation duration, an activation end date, or other information. The information may be stored in an electronic record associated with a license to the hardware or software.

With this information available, neither the purchaser 10 nor the vendor needs to rely on a generic user manual. Instead, the vendor may provide a customized automated installation process (CAIP) 150 to the purchaser 10. The CAIP 150 may cover only what the purchaser 10 purchased and exactly what the purchaser 10 purchased. The CAIP 150 may provide a linear installation experience where the installer simply follows directions without having to make decisions.

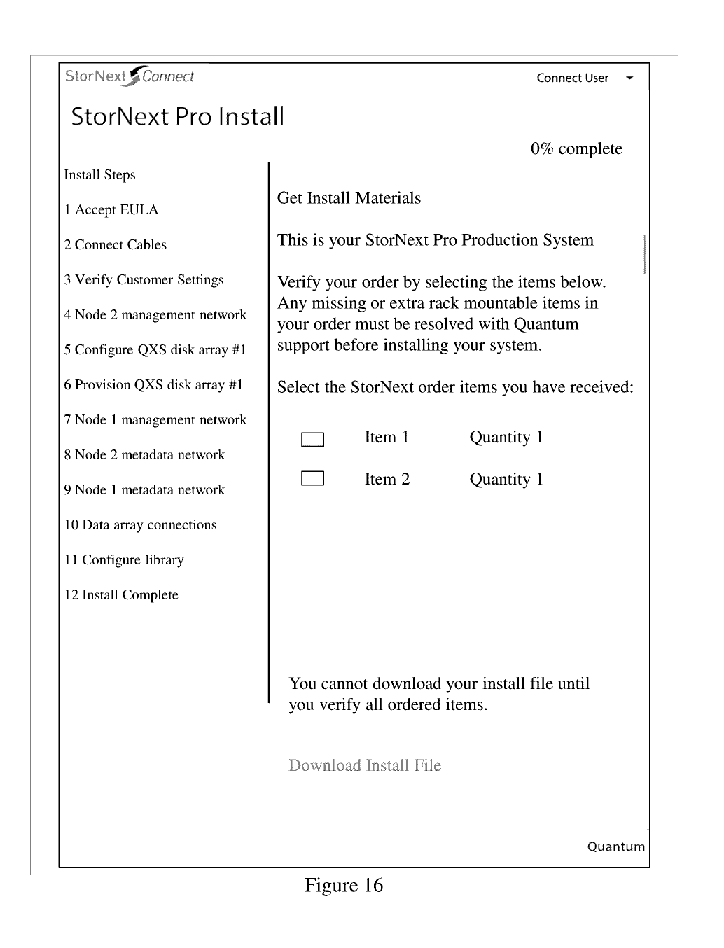

Information from the purchase capture 100 may be provided to a database (e.g., install base 110). At some point after the purchase, there will be a hardware/software delivery 120. When the purchaser 10 receives the hardware/software delivery 120, the purchaser 10 is provided with information for performing registration 130. Registration 130 occurs after purchase and before installation. Registration 130 thus provides an opportunity to verify that the purchaser 10 has received the items that were identified at the purchase capture 100. The vendor acquires information from the registration 130 and produces a bill of materials that is delivered at 140. FIG. 16 illustrates a screen shot associated with verifying that the purchaser 10 has received the items that were identified at the purchase capture 100. The verification step may occur before the purchaser 10 is presented with an end user license agreement (EULA). The purchaser 10 and the vendor can reconcile the hardware/software delivery 120 with the purchase and the bill of materials. Detecting a registration 130 may include receiving data from a purchaser computer, receiving data through a website, receiving data telephonically, or other actions.

When the purchaser 10 verifies that they received what they purchased, and when the vendor verifies that the purchaser 10 has received what was purchased, then the purchaser 10 can activate CAIP 150. The CAIP 150 knows what the purchaser 10 purchased and knows how to provide information to facilitate guiding the installation of what was purchased. The CAIP 150 may run on a separate computer (e.g., laptop, tablet computer, smart phone) that can display customer specific information. The separate computer may be independent of the hardware or software that the purchaser 10 is installing. The customer specific information may include text, graphics, videos, links to additional information, live links to tech support 160, and other information. In one embodiment, the CAIP may run on the hardware purchased, or on the separate computer and the hardware purchased.

The CAIP 150 guides the purchaser 10 through hardware installation, software installation, and configuration until a verified running system is produced or until an unresolvable failure is detected. The CAIP 150 may proceed in a step-by-step manner where individual steps are verified and logged before next steps are attempted. Individual steps may include, for example, connecting a cable. Thus, in one embodiment, an installer may be presented with a photograph or video of the attachment points for the cable. The photograph or video may be annotated to indicate connection points that are appropriate for the particular combination of hardware and software that were purchased. In one embodiment, to insure that the annotated photograph is as up-to-date as possible, the purchaser 10 may take a picture of their actual hardware and provide it to the CAIP 150. The CAIP 150 may then perform pattern recognition on the picture to insure that the hardware in the picture matches the purchased hardware. The provided picture can be annotated and provided back to the purchaser 10 by the CAIP 150. The provided picture may be annotated automatically.

Once the installer indicates that a cable has been attached, the CAIP 150 may verify that connectivity exists between the points connected by the cable. In one embodiment, connectivity may be verified electrically. In one embodiment, the CAIP 150 may cause an electrical signal to be sent along the cable and may report on the result. If connectivity is achieved, installation may proceed. If connectivity is not achieved, the CAIP 150 may take remedial steps including, for example, prompting the installer to try different locations, providing an additional video, or even having tech support 160 text, email, or telephone the purchaser 10.

Individual steps may also include, for example, providing and verifying network addresses or other addresses. Thus, in one embodiment, an installer may be presented with a data input screen that seeks addresses. Once the installer indicates that the addresses have been entered, the CAIP 150 may verify that communications with the desired sites have been established. In one embodiment, communications may be tested by the CAIP 150 causing a data communication to be sent to or from the location identified by the network addresses or other addresses. If communications are established, then installation may proceed. If communications are not achieved, the CAIP 150 may take remedial steps including, for example, prompting the installer to try different addresses, providing an additional graphic or video, or even having tech support 160 text, email, or telephone the purchaser 10. Unlike conventional systems where data (e.g., addresses) may be entered into the hardware or software being configured using the hardware or software being configured, which requires the purchased platform to include a data entry and data display capability, example apparatus and methods may allow data (e.g., addresses, security codes, license information) to be entered using a separate device (e.g., laptop, tablet, phone) that is connected to the purchased platform. This may reduce or eliminate the need to have data entry or display capability included in the purchased platform. Example methods and apparatus thus improve on conventional approaches by facilitating the installation of a purchased platform with the consumption of fewer resources. For example, not requiring a dedicated monitor and keyboard at a server farm may reduce the physical footprint required to maintain the server farm.

The CAIP 150 may also include, for example, provisioning a device. Provisioning a device may include, for example, acquiring data, credentials, certificates, tokens, security tokens, keys, or other information that the hardware or software need to operate correctly. In one embodiment, the CAIP 150 may cause the provisioning to occur by sending computer instructions via a data communication to the hardware or software. If provisioning completes successfully, then installation may proceed.

An installation log may be produced during installation. The installation log may record decisions made and actions taken by the installer. For example, the installation log may record cable insertion locations, electrical connectivity test results, addresses used, data connectivity test results, provisioning results, or other information. The installation log may be available to tech support 160. Thus, in one embodiment, if the purchaser 10 calls tech support 160, the problem space in which tech support will operate is reduced over conventional systems because tech support 160 will have data about what the purchaser 10 has been trying, to what point the installation has proceeded successfully, what has worked, and what did not work. Additionally, tech support 160 will have the installation log that explains where the purchaser 10 is in the installation process. This facilitates producing efficiencies in tech support that may reduce the time required to manage a customer interaction, which in turns reduces the amount of money spent on customer support. Rather than having to ask questions that may be answered slowly or inaccurately, tech support 160 will have an actual record of the actual state of the installation.

The process flow in FIG. 1 shows how purchaser identity and purchase particulars (e.g., actual purchased items) can be verified through registration, how a CAIP 150 can be provided to the purchaser 10, and how tech support 160 can be provided with instantaneous up-to-date installation information. The installation does not rely on a generic user manual or generic installation video or graphics. Instead, a customized approach is provided on a per purchase and per purchaser basis. This facilitates reducing inefficiencies and facilitates reducing wasted time. An installer may feel like an individual that is respected by the vendor, rather than as a fungible customer that is left to their own devices to try to install complicated hardware and software.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a circuit. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, circuit, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

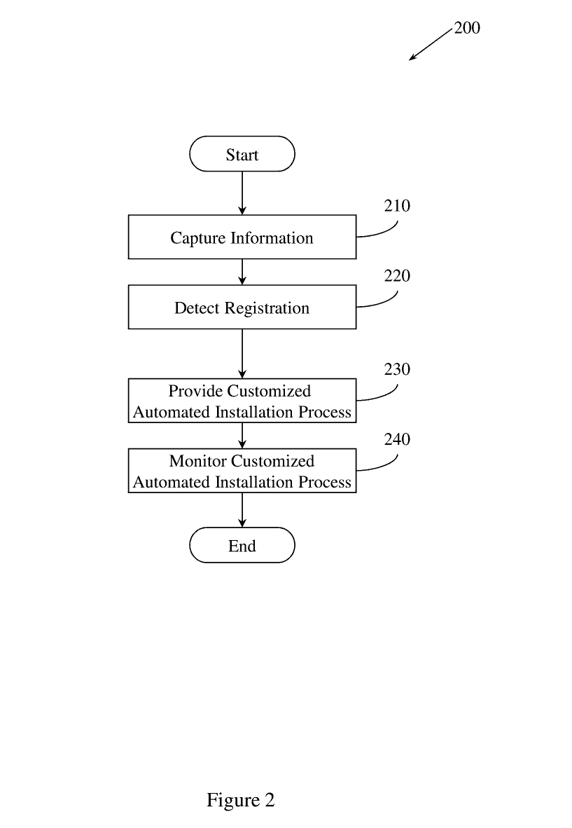

FIG. 2 illustrates a method 200 for providing a CAIP. Method 200 includes, at 210, capturing information about a purchase of computer hardware or software. The information may include, for example, the hardware purchased, the software purchased, the purchaser, a license start date, a license end date, license particulars, an activation date, an activation duration, an activation end date, or other information. Capturing the information may include receiving or producing electronic data that is stored in a computer readable memory or device. The information may be received from a point of sale (POS) device, from a vendor server, from a vendor website, from a third party website, or from other locations or devices.

Method 200 also includes, at 220, detecting a registration associated with the purchase of the computer hardware or software. The registration may include, for example, identifying information provided at the time of purchase. The registration may also include, for example, identity confirmation, reconciling a purchaser to a purchase, or other synchronization information. Detecting the registration may include determining that an electronic record has been received from the purchaser, detecting that an electronic communication has been made by the purchaser, or other action.

Method 200 also includes, at 230, providing a CAIP. The CAIP may provide a linear graphical experience through the installation of the computer hardware or software. The experience is graphical in that graphic information (e.g., photographs, diagrams, videos) are presented. The experience is linear in that the installer does not have to make decisions at branch points. Branch points are locations where two or more options are available. The linear experience may include a series of steps for which graphic information (e.g., photographs, diagrams, videos) are provided.

Method 200 also includes, at 240, monitoring the CAIP. Monitoring the CAIP at 240 may include verifying that the hardware or software are being installed and configured in accordance with the customized installation instructions and presentation provided by the CAIP. In one embodiment, each step may be verifiable. In another embodiment, sets of steps may be verifiable. While graphic information is described, in one embodiment, non-graphical information (e.g., audio) may be presented. In one embodiment, members of the series of steps are verified at 240 on a per step basis and an installation log is maintained on the per step basis. In one embodiment, successes or failures at a step may cause an automated communication with tech support. In one embodiment, the CAIP provides a graphic presentation from a device (e.g., server) associated with the hardware or software provider. The graphical presentation is displayed at the installation location. The graphical presentation may be displayed on a computer (e.g., laptop, smartphone) other than a computer that is part of the hardware purchased. The graphical presentation may include a user interface (UI). In another embodiment, the CAIP itself is provided as computer executable instructions that are run on a device at the installation site. When run, the computer executable instructions cause the second device at the installation site to provide the presentation.

In one embodiment, providing a CAIP or monitoring a CAIP may include sending a message from a laptop, tablet computer, smart phone, or other device being used by an installer to implement a CAIP for purchased hardware or software, to a server associated with the hardware or software provider. The message indicates to the server to start processing the installation. Upon receiving the message to start processing the installation, the server starts processing the installation. While the server processes the installation, the device (e.g. tablet computer, smart phone, laptop) polls the server for the server's status. The server may have a “working” status, a “finished” status, or other status. A “working” status includes information containing details regarding the server's current progress in processing the installation. For example, a first step in the installation process may require thirty sub-steps to be completed by the server. The server may generate updated statuses as the server progresses through the thirty sub-steps. As the device polls the server for status updates over time, the server may indicate with a first working status to the device that it has progressed to, for example, sub-step twenty out of a predicted thirty sub-steps. At some later time, the server may indicate to the device with a second working status that it has progressed to sub-step twenty-five out of the predicted thirty sub-steps. In this manner, example methods and apparatus facilitate making the installer feel like they are being treated respectfully, rather than as a fungible asset, because the installer will be less likely to wonder what is going on at the server side. A finished status may indicate that the server has successfully completed the step. A finished status may, alternately, indicate that the server has encountered a failure in attempting to complete the step. Throughout the process of providing a CAIP, the server may pause the installation and send updated graphical presentations, or UI, to the device for the specific step the server is processing. The updated UI may include an error message instruction, or a success message instruction, to assist the installer with continuing the install. After the installer acknowledges the UI and clicks to continue, the server will continue processing CAIP steps and providing updated customized UI to the installer until the server encounters a step that requires a user action, or until the installer decides to quit or abort the install.

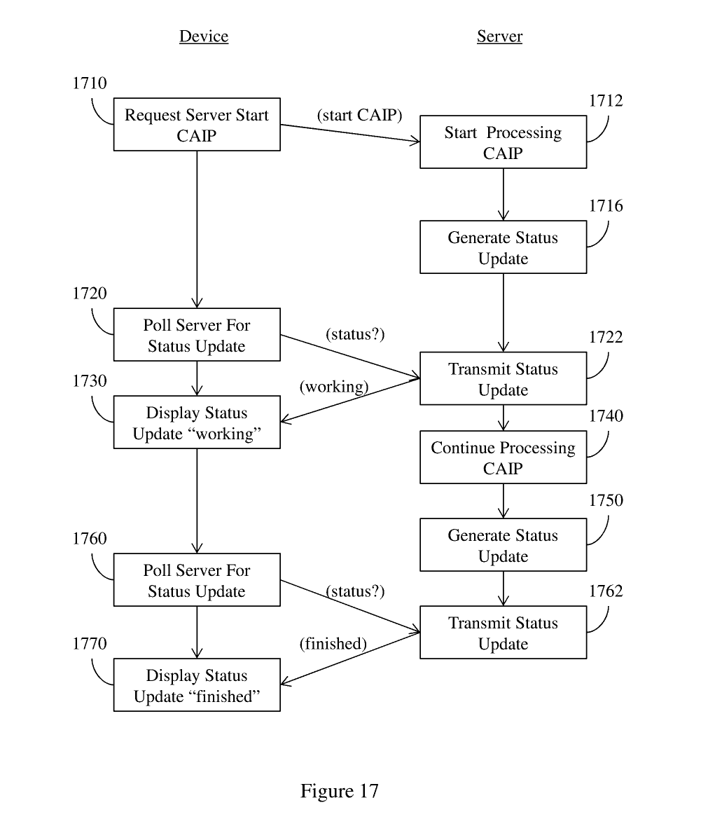

FIG. 17 is a flow diagram illustrating one possible implementation of example methods described herein. FIG. 17 illustrates a sequence of steps taken by a device (e.g. laptop computer, tablet computer, smart phone) and a server, and communications between the device and the server, during an installation of purchased hardware or software. The device may be, for example, a laptop computer, a tablet computer, or a smartphone used by an installer. The installer may be a purchaser or other user installing purchased hardware or software. The device and the server may communicate across a local area network, a wide area network, a wireless connection, a wired connection, over the internet, or through other communications techniques. At 1710, the device requests that the server start the CAIP. A message is sent to the server to start the CAIP. At 1712, the server receives the message to start the CAIP, and begins processing the CAIP. As the server processes the CAIP, it generates a status update at 1716. The status update generated at 1716 may indicate that the server is “working” on the CAIP. The status update generated at 1716 contains customized information for the particular hardware or software installation being processed. The device, at 1720, polls the server for a status update. The server, upon receiving the poll for a status update, transmits at 1722 the status update generated at 1716. The device receives the status update at 1730, and displays, on the device, the status update “working”. The status update may include customized updated UI to guide the installer through the CAIP. The status update also includes information that the device displays to the installer indicating what percentage or proportion of the CAIP the server has completed processing. The server continues processing the CAIP at 1740. At 1750, the server generates another status update. In this example, the status update generated at 1750 indicates that the server has finished processing the CAIP. At 1760, the device polls the server for another status update. Upon receiving the poll for a status update, the server, at 1762, transmits the status update generated at 1750 to the device. The device, at 1770, displays the status update “finished”. In one embodiment, the device may poll the server at a fixed interval (e.g. one second, ten seconds) or the device may poll the server at a variable interval. In another embodiment, other numbers or types of devices may be employed, and other numbers or types of servers may be employed.

In one embodiment, the server may process the installation with one, more than one, or no devices interacting with the hardware being installed. For example, a first installer may initiate the install process using a laptop. The first installer may, after some time (e.g. thirty minutes), disconnect the laptop from the hardware being installed and go have lunch. The server continues on processing the CAIP in the absence of the laptop, and may pause the installation at the next step requiring user input. The installer may return from lunch and reconnect the laptop to the hardware being installed. Upon reconnecting the laptop the installer will be presented with the current status of the installation. The current status of the installation indicates if the server is still processing, or the UI action needed to continue processing the installation. In another situation, a first installer may initiate the installation with a laptop, disconnect the laptop, and a second installer with a smart phone and a third installer with a tablet computer may connect to the hardware being installed and continue the installation. The server sends the customized installation information to the smart phone and the tablet computer now being used in the installation. Then, the second installer and the third installer continue the installation where the first installer left off. In another embodiment, the installer may communicate to the server, via, for example, a web browser, a text message, or an email, that the installer intends to pause installation for a period of time. The installer may, after some period of time (e.g. one hour) communicate to the server that the installer intends to continue the paused installation. In another embodiment, an installer may connect to the hardware being installed using a conventional approach, (e.g. connecting a keyboard and monitor to the hardware) and initiate the install process using the hardware that has been purchased.

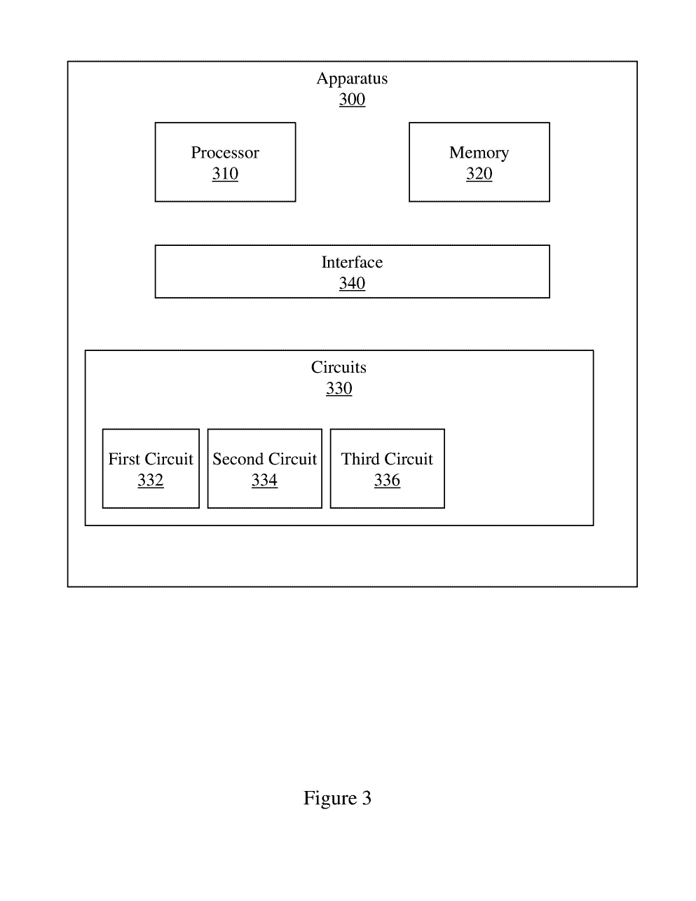

FIG. 3 illustrates an apparatus 300 that supports providing a CAIP. Apparatus 300 includes a processor 310, a memory 320, and a set 330 of circuits that is connected to the processor 310 and memory 320 by an interface 340. The processor 310 may be, for example, a microprocessor in a computer, a specially designed circuit, a field-programmable gate array (FPGA), an application specific integrated circuit (ASIC), a processor in a mobile device, a system-on-a-chip, a dual or quad processor, a virtual processor, or other computer hardware.

The memory 320 may be configured to store information about a purchase by a customer. The information may identify computer hardware and software purchased by a customer. The information may include a model number, a version number, a revision level, an activation date, a purchase date, or other information. The memory may also store information about an ongoing installation. This information may identify a point to which an install has progressed. The information may also include an install log that stores information about decisions made during installation, results obtained during installation, connectivity tests performed during installation, performance data, and other information. In one embodiment, the memory 320 may store instructions that when executed perform at least a portion of the CAIP.

The set 330 of circuits may include a first circuit 332 that captures electronic data about the purchase. The electronic data may be captured at the time of sale by the vendor. Capturing the electronic data may include, for example, receiving an electronic purchase record, parsing information out of an electronic purchase record, or other actions. Capturing the electronic data may be performed at, for example, a point of sale device, a vendor website, a third party website, a vendor server, or other location.

The apparatus 300 may also include a second circuit 334 that provides a customized presentation from a CAIP. The presentation may be customized based, at least in part, on the electronic data about the purchase information. For example, the purchase information may be examined, the precise hardware and software identified, and then the ordered steps that are required to install the particular software on the particular hardware are added to the presentation provided by the CAIP.

In one embodiment, the CAIP may run on the apparatus 300 and provide a graphical presentation that is displayed to an installer on a second, different apparatus. The second apparatus may not be part of the purchase. In another embodiment, the second circuit 334 may provide the CAIP as computer executable instructions to the second apparatus which then makes the customized presentation in response to executing the instructions on the second apparatus. Thus, example apparatus and methods differ from a conventional install wizard that is provided to a computer to configure or install hardware or software on the computer to which the install wizard is provided. A difference is that the information is being presented by a second device other than the device being configured. Example apparatus and methods also differ from a conventional installation video because the presentation is customized to the actual purchase using information from the purchase and using information acquired during the install.

The apparatus 300 may also include a third circuit 336 that monitors the CAIP. Monitoring the CAIP may include, for example, maintaining an installation log that records attempted actions and the results of the attempted actions. The actions and results may include, for example, cable connections and electrical connectivity tests, address provisioning and data communication tests, provisioning and testing, or other actions and results. Monitoring the CAIP may also include providing real-time up-to-date information to tech support, which may facilitate more rapid response to an individual problem encountered by an installer during the installation. While real-time progress may be reported, in one embodiment, to conserve bandwidth, the log is only provided if an error occurs. Maintaining the installation log also facilitates restarting an installation after an installer pauses the installation.

In one embodiment, the functionality associated with the set of circuits 330 may be performed, at least in part, by integrated circuits including, but not limited to, field-programmable gate arrays (FPGAs), application specific integrated circuits (ASICs), application specific standard products (ASSPs), system on a chip systems (SOCs), or complex programmable logic devices (CPLDs). In one embodiment, all of circuits 332, 334, and 336 may be implemented as ASICs or other integrated circuits or circuits. In one embodiment, circuits 332, 334 and 336 may be implemented as a single ASIC or other integrated circuit or circuit. In one embodiment, circuit 332, 334, or 336 may be a virtual circuit whose functionality is provided by instructions that are stored in memory 320 and executed by processor 310.

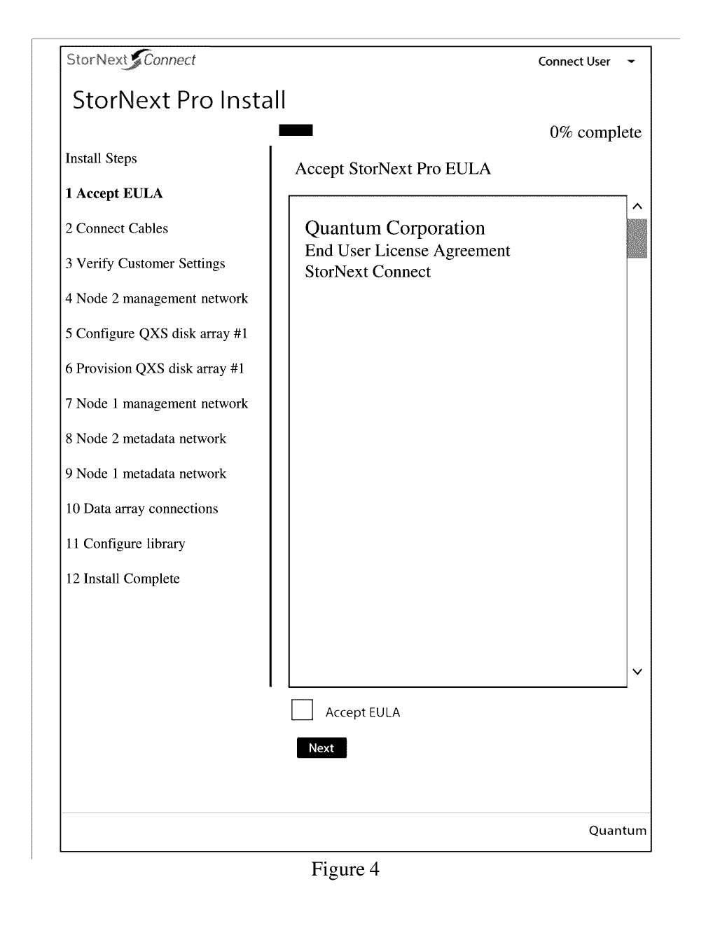

FIGS. 4 through 15 are screen shots that illustrate one example twelve step process associated with one example customized automated install process. The screen shots illustrate data capture screens, photographs of cable installation locations, configuration screens, license agreement screens, and other information. While a twelve step process is illustrated, it is to be appreciated that a greater or lesser number of steps may be involved with different purchases and that steps may be performed in different orders.

The screen shots are representations of images presented on a computer that is being used during the installation of the computer hardware and software but that is not part of the purchased hardware or software. This improves over conventional install wizards that run on the computer that is being installed or configured because a separate device that is already known to be functioning properly is used to bring up the new hardware or software, rather than having to use the new hardware or software. This also facilitates reducing costs for the new hardware or software because no display may be needed for the new hardware or software. Instead, the display on a separate device may be employed. Additionally, test results may be provided automatically to the computer providing the customized presentation. Conventionally, a failed test on hardware or software being installed may cause the items being installed to hang or otherwise fail. By running the CAIP on external hardware, a failed test may be less likely to hang up the external hardware, which allows the external hardware to report on the installation process.

In this embodiment, there are no decisions or branch points for the user. Instead of having to identify their equipment or version or configuration, the CAIP proceeds in a linear fashion with no decision points for the user. Removing forks in the installation road reduces the likelihood that the installer will travel down an undesirable path.

FIG. 4 illustrates a screen shot associated with a first step in an example installation. The first step includes accepting an end user license agreement. Which end user license is presented will depend on the combination of hardware and software purchased. Thus, the installation is customized at this very first step. The customization may occur and the presentation may begin before the hardware or software being installed is active.

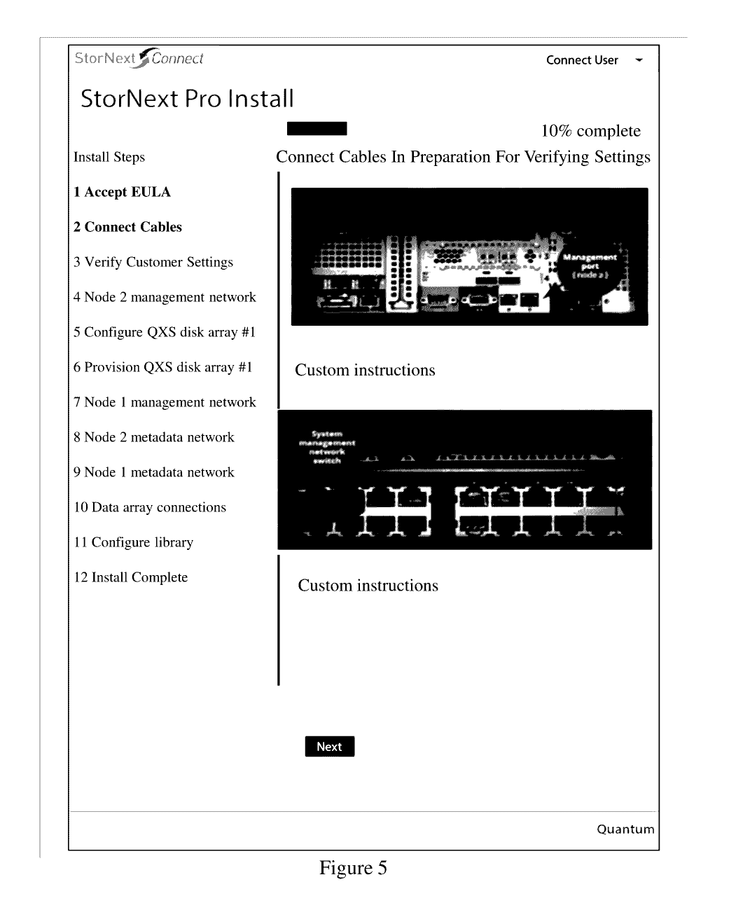

FIG. 5 illustrates a screen shot associated with a second step that includes connecting cables. Photographs of hardware corresponding to the purchased hardware are presented. Annotations on the photographs identify where cables should be connected. Once the cables have been inserted, electrical connectivity can be verified. Once the connectivity is verified, then the next step may proceed. If the connectivity cannot be verified, in one embodiment, the CAIP may contact tech support on behalf of the installer. In another embodiment, the failed connectivity may be logged and the log may be available to the installer and tech support at a later time. If connectivity cannot be verified, example methods and apparatus may determine that there is no point in proceeding to other installation steps and the automated process may terminate. In one embodiment, to increase security and installer confidence, the installer may be prompted to take and provide a photograph of the hardware they are installing. The photograph from the installer may then be annotated by the CAIP. Security may be increased by doing pattern recognition on identifiers (e.g., bar code, QR code) that are displayed on the hardware. The photograph from the installer may be pattern matched with vendor photographs or diagrams of intact, undamaged equipment to insure that the hardware being installed is not compromised. This approach may improve physical security and de-incentivize a potential thief because installing the hardware may require providing a photograph of the hardware at installation time.

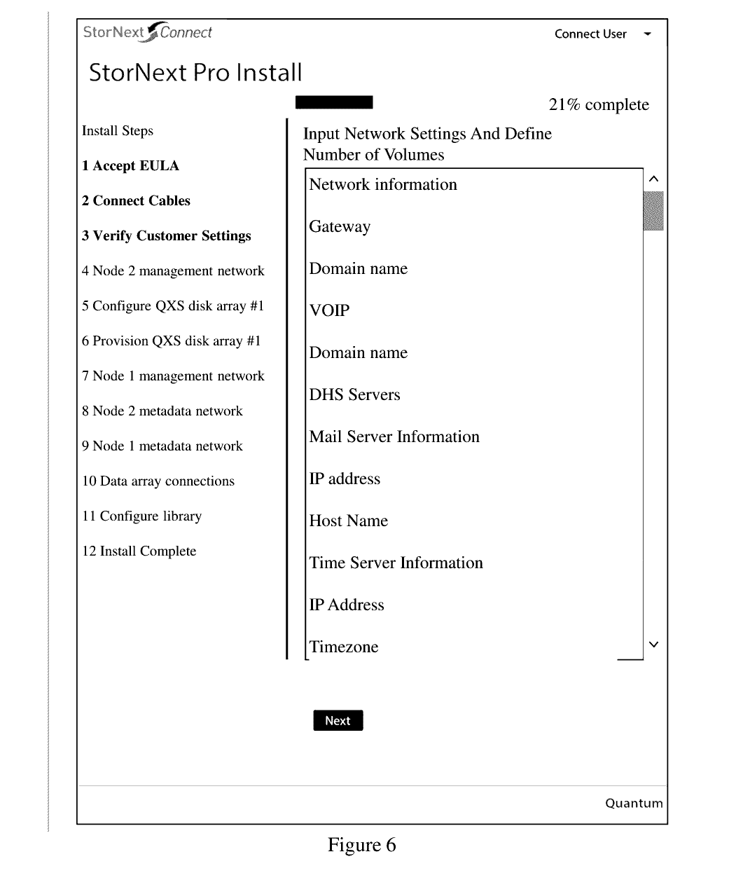

FIG. 6 illustrates a screen shot associated with inputting network settings including IP addresses. Once the addresses have been input, basic communication with those addresses can be verified. When the basic communications have been verified, then the next step may proceed. In a custom installation, only the addresses needed for the actual hardware and software purchased may be requested and verified. This may reduce installation time and improve security by only asking for the minimum number of addresses and keeping track of which addresses were actually used.

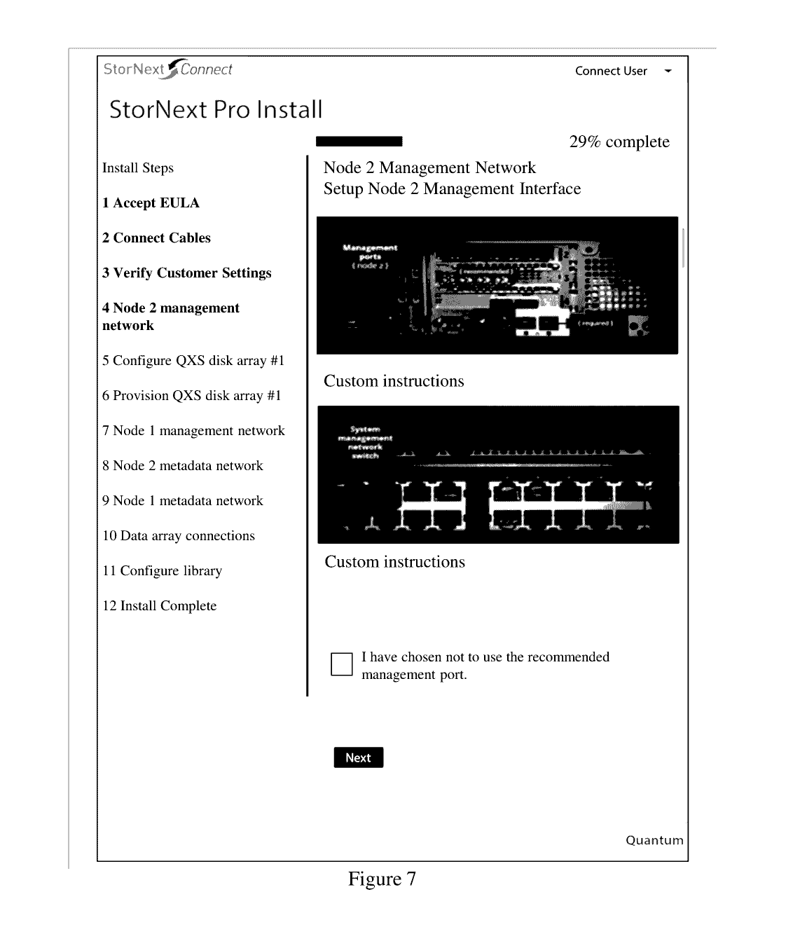

FIG. 7 illustrates a screen shot for connecting additional cables. Once again, a photograph or diagram corresponding to the actual hardware purchased is displayed. Which cables need to be connected and the ports in which they are to be attached may change based on the hardware purchased, the software purchased, or the combination of hardware and software purchased. The same hardware may be cabled differently depending on the software that it will run. Therefore, the customized presentation of the actual hardware may be annotated based, at least in part, on the actual items being installed. In one embodiment, photographs provided by the installer may be annotated and displayed to the installer. Additionally, which cables need to be connected and the ports in which they are to be attached may change based on earlier performed steps. Therefore, the customized presentation of the actual hardware may be annotated based on the previous steps.

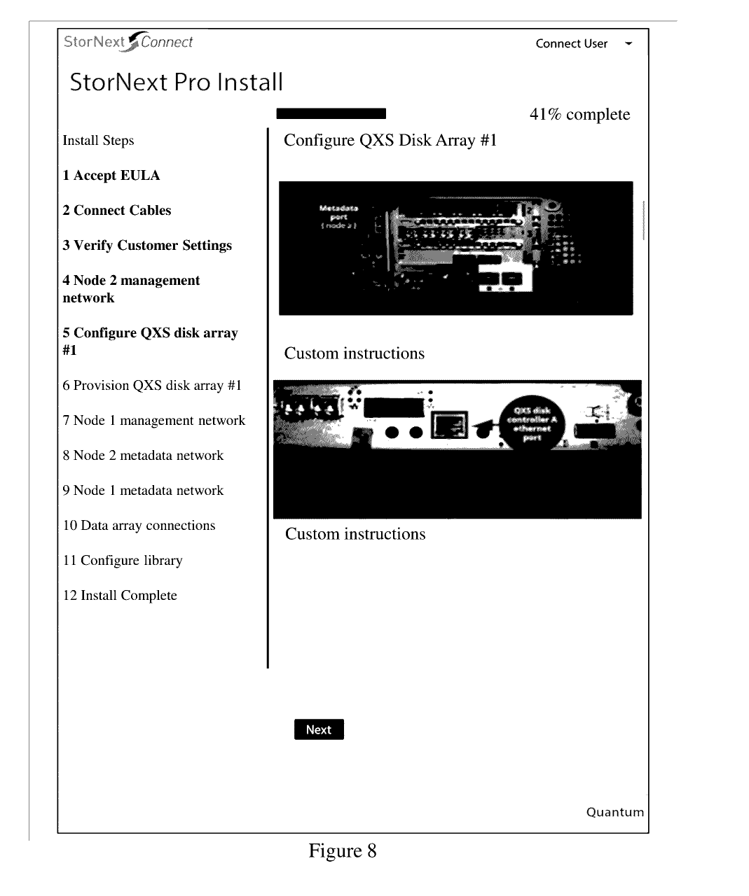

FIG. 8 illustrates a screen shot for connecting even more cables. Photographs or diagrams corresponding to two pieces of purchased hardware are displayed. The correct ports for the cable connections are identified in the screen shot. Which ports are to be used may depend on the combination of hardware or the combination of hardware and software. Once the cables have been installed and connectivity has been verified, installation may proceed to the next step. In one embodiment, this may be an interactive process where annotations are provided on an as-needed basis to insure a proper order for the cabling or installation.

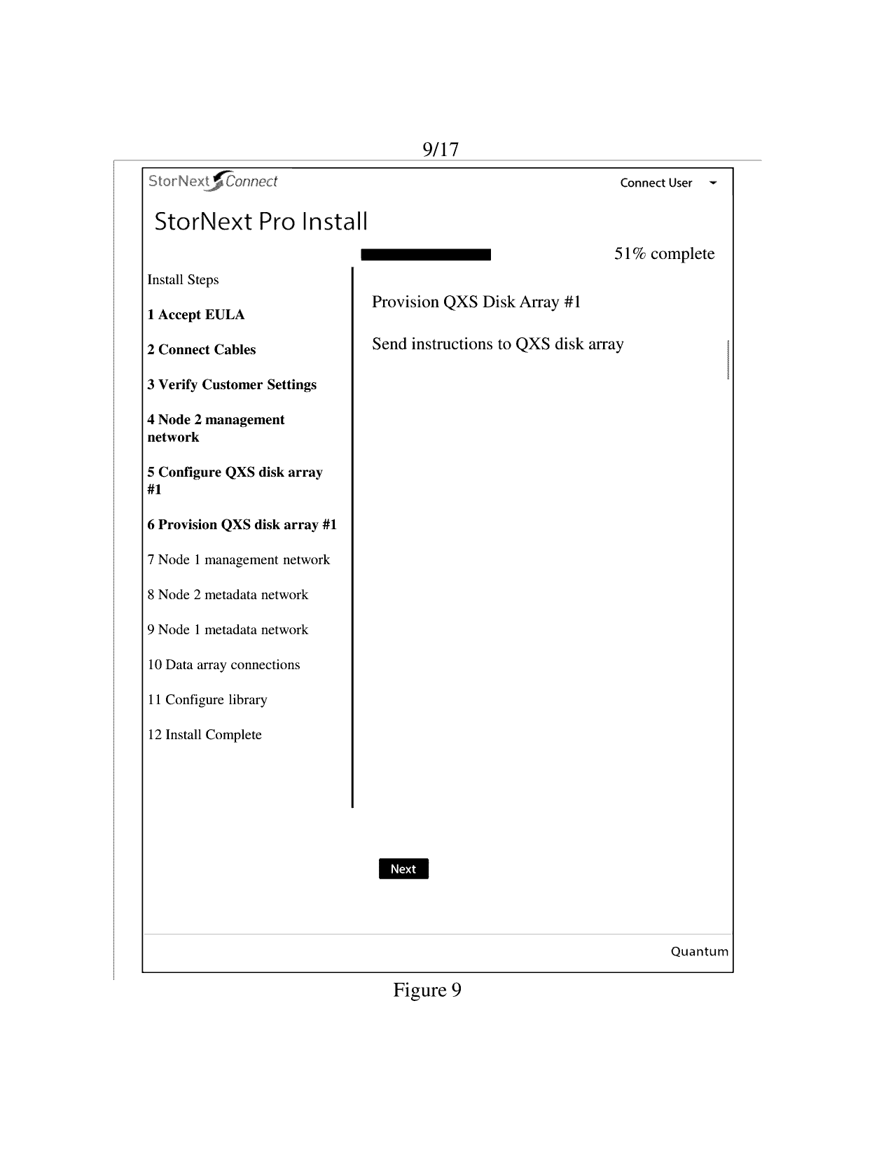

FIG. 9 illustrates a screen shot associated with provisioning a piece of the purchased hardware and the software running thereon. The hardware and software may know what information they need to acquire or generate and thus this provisioning step may include sending an instruction to the hardware or software to begin provisioning itself. The log may track what information was acquired or produced. Once the device has successfully completed the provisioning, installation may proceed to the next step.

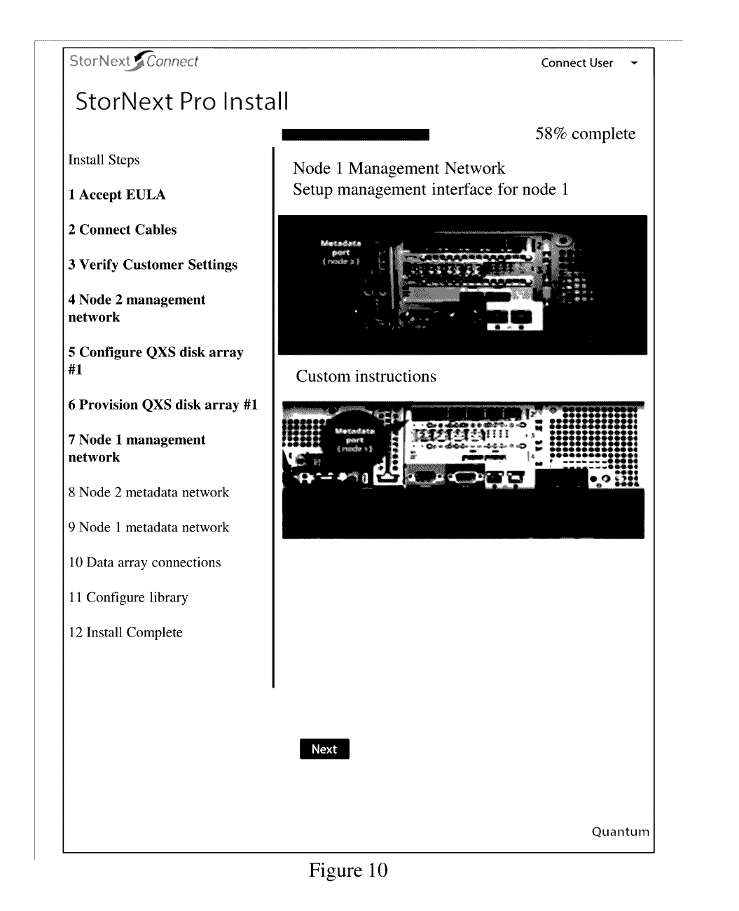

FIG. 10 illustrates another cabling screen shot. Once again, actual photographs or diagrams of the purchased hardware that is being installed may be presented. The photographs may be standard photographs from the hardware provider or may be photographs taken by the installer and provided to the CAIP. The photographs are annotated with identifiers that are appropriate for the combination of hardware and software and the point to which the installation has proceeded. Once the cables have been installed and connectivity has been verified, installation may proceed to the next step. As can be seen from the numerous cabling screen shots, installing a combination of hardware and software may include connecting numerous cables. Having even one cable in the wrong spot can cause the installation to fail. Therefore, in one embodiment, the CAIP proceeds in a step-by-step fashion where cable connections are performed one at a time with verification following the connections. This may increase installation efficiency while reducing installer frustration. This may also increase efficiency in the installed system because optimization may be performed at multiple steps in the installation based on actual reported results of electrical and data connectivity tests.

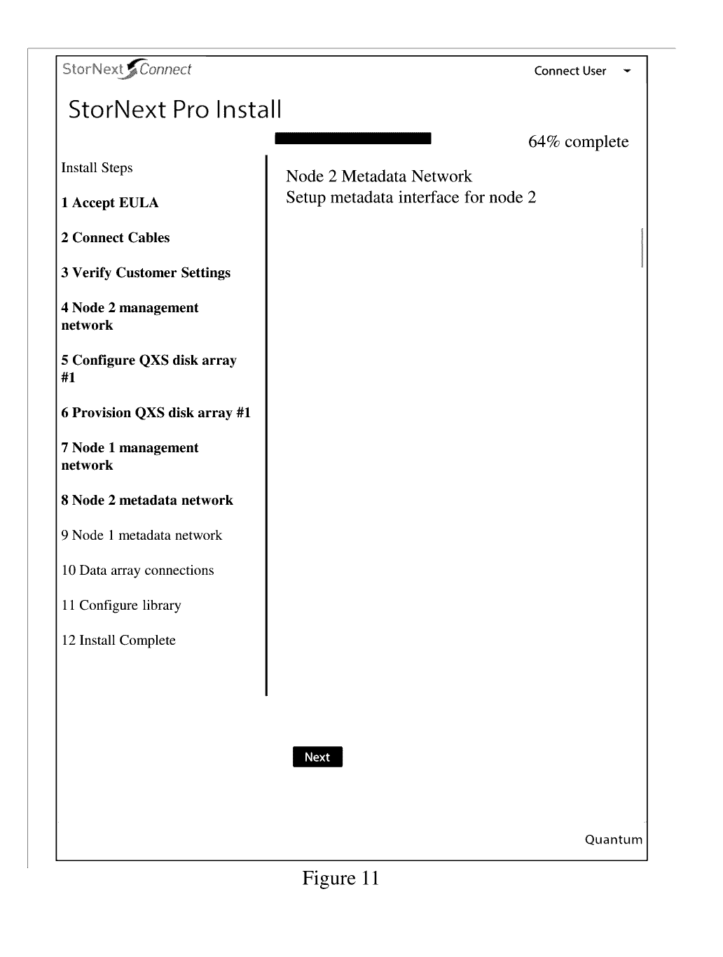

FIG. 11 is a screen shot of a next step that involves setting up IP addresses. Example methods and apparatus may determine that there is no point starting this step if previous cabling and provisioning steps have not been completed and verified. This facilitates improving the customer experience and the ability of tech support to resolve an installation issue. Users will not waste time performing steps that are premature or pointless. Tech support will know which steps have completed successfully and where the user is having problems. Security may be improved because IP addresses may not be entered until previous steps have been completed. Thus, IP addresses may not be exposed to systems that have not been installed according to the CAIP.

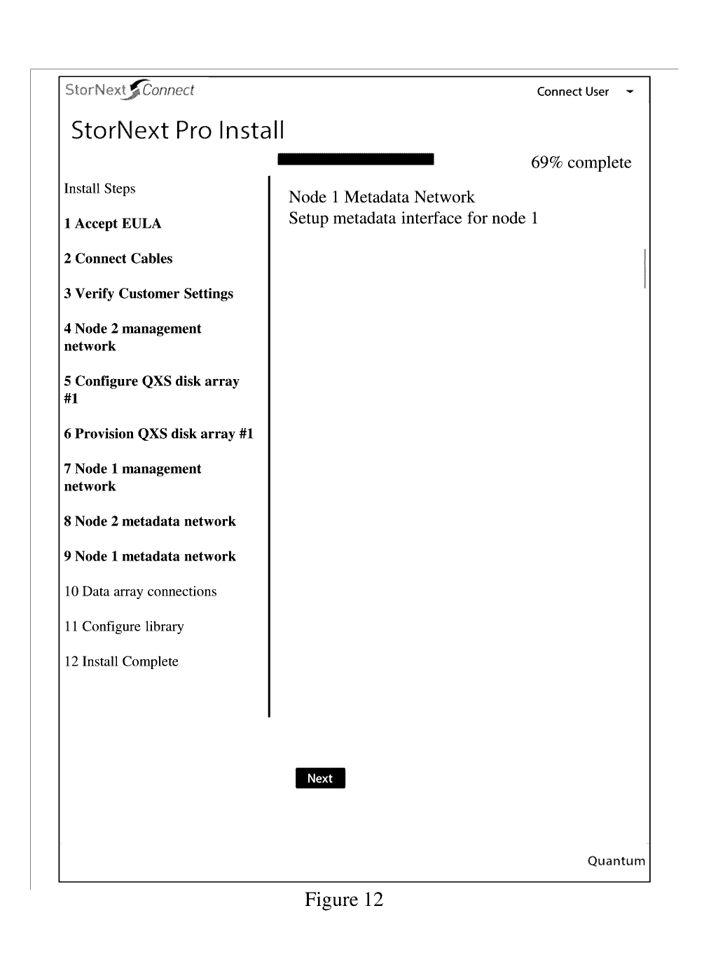

FIG. 12 is a screen shot that also involves setting up IP addresses. Establishing communications between various hardware and software components may require a certain order to be followed. There may be no point in entering the IP addresses in FIG. 12 if the IP addresses entered in FIG. 11 were not verified and usable. Additionally, which IP addresses to use in FIG. 12 may not be known or knowable until after the IP addresses in FIG. 11 have been input and verified. Once the IP addresses have been validated, the next step can proceed. In one embodiment, which IP addresses to use may be determined by the CAIP at install time. The IP addresses may be selected based, for example, on load balancing issues, address availability, network bandwidth consumption issues, price, security, or other considerations. Selecting IP addresses, cable connection points, or other presentation choices based on these considerations and the results of previous steps provides opportunities to optimize both the installation process and the combination of hardware and software being installed.

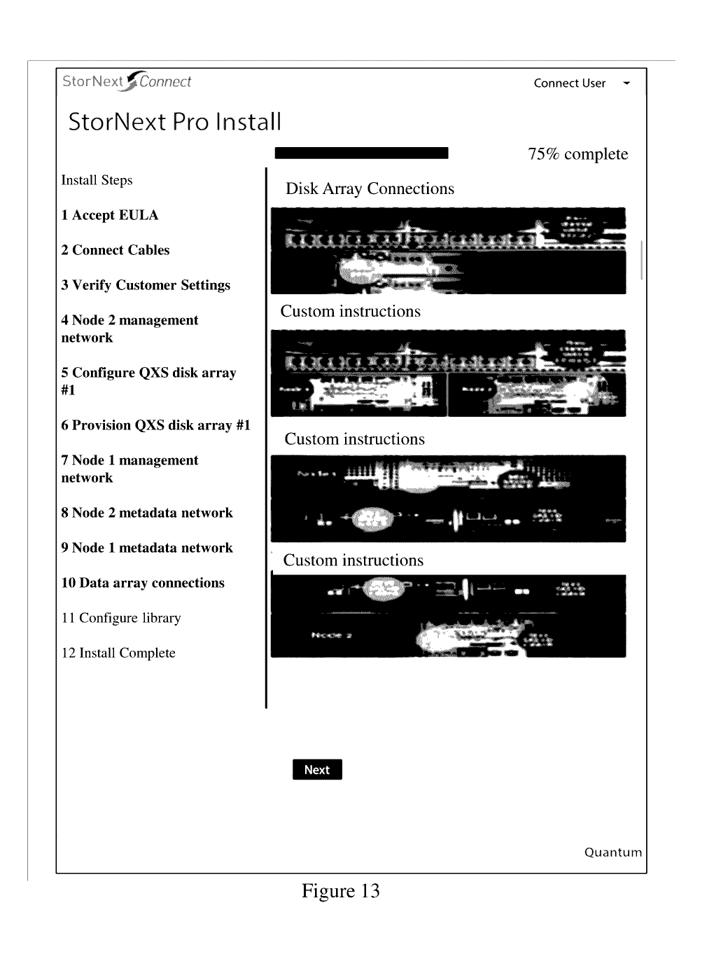

FIG. 13 illustrates yet another cabling screen shot. Some installations may involve connecting dozens or even hundreds of cables. Photographs or diagrams of hardware that is identical to or substantially similar to the purchased hardware or the actual purchased hardware itself are displayed. In one embodiment, the photographs or diagrams are annotated with highlights or bubbles to help the user identify the correct cable locations. The correct cable locations may not be known until after the IP addresses have been entered and verified and until after other cables have been connected. For example, an earlier attempt to connect cables may have determined that a certain port was not functioning and thus a port that might have been used in this step is no longer available. Therefore, the CAIP may be aware of which ports are still available and automatically update the installation presentation to account for what is actually happening. Thus, the CAIP may be dynamic in that what is displayed at a subsequent step may depend on what has happened at a previous step or steps.

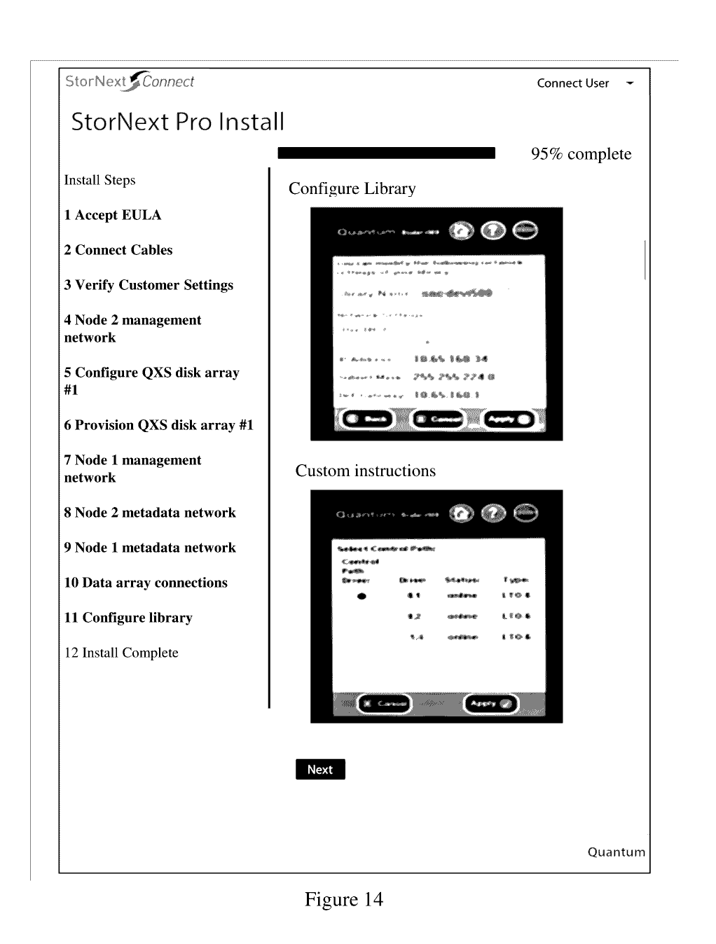

FIG. 14 is a screen shot of a data entry screen. The data entry screen may be unique or customized based on the combination of hardware. The data entry screen may also be unique or customized based on what has happened at earlier installation steps. Unlike conventional manuals or install wizards that may try to anticipate a generic situation and provide a generic solution, example CAIP track an actual installation and provide real-time guidance based on the progress of the actual installation.

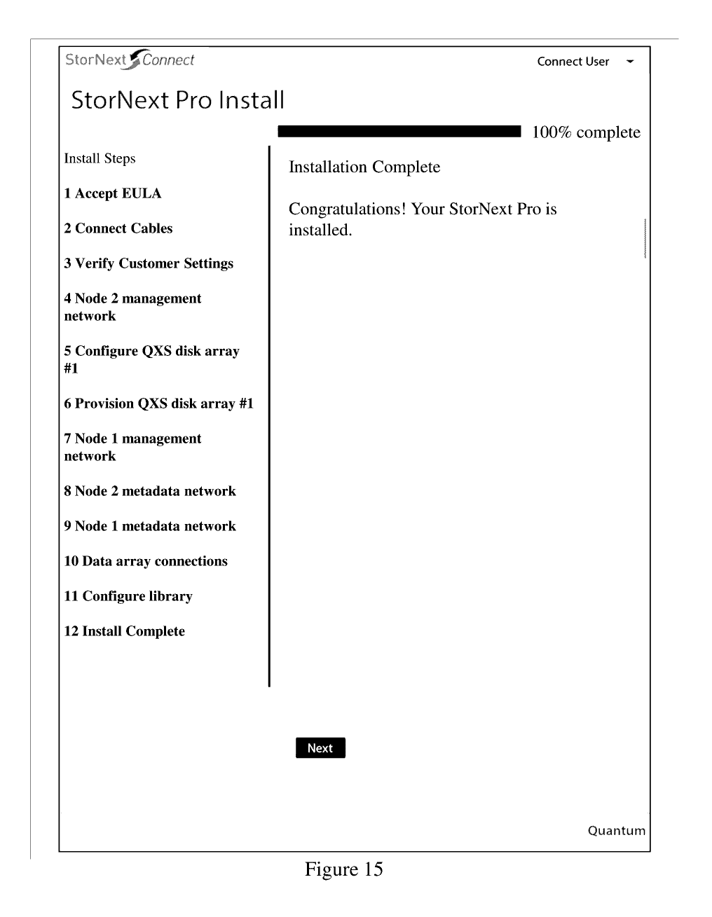

FIG. 15 is a screen shot of a completion screen. In one embodiment, an installation log may be created and maintained during installation. When the completion screen is presented and acknowledged, the installation log may be stored or transmitted. For example, the installation log may be transmitted to tech support to record the successful installation. If the installation had failed at an earlier step, the installation log may have been transmitted at that earlier time to facilitate debugging the installation.

Note that during the 12 step process, the user did not have to make any decisions at any branch points. Any branching was transparent to the user. The user experienced a linear, graphic presentation with verification at the various installation steps. This provides a superior user experience and increases the efficiency of the installed hardware and software by insuring that cables, IP addresses, and other data and hardware are set up correctly. In other embodiments, other numbers of steps may be employed.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and other similar exemplary language indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer component”, as used herein, refers to a computer-related entity (e.g., hardware, firmware, software in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication”, as used herein, refers to a communication between computing devices (e.g., computer, personal digital assistant, cellular telephone) and can be, for example, a network transfer, a file transfer, an applet transfer, an email, an HTTP transfer, and other transfer. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and other system.

“Computer-readable storage device”, as used herein, refers to a device that stores instructions or data. “Computer-readable storage device” does not refer to propagated signals. A computer-readable storage device may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage device may include, but are not limited to, a floppy disk, a flexible disk, a hard disk, a magnetic tape, other magnetic device, an application specific integrated circuit (ASIC), a compact disk (CD), other optical device, a random access memory (RAM), a read only memory (ROM), a memory chip or card, a memory stick, and other media or device from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data. A data store may be, for example, a database, a table, a file, a data structure (e.g. a list, a queue, a heap, a tree) a memory, a register, and other stores. In different examples, a data store may reside in one logical and/or physical entity and/or may be distributed between two or more logical and/or physical entities.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, and other items, that can be received, transmitted and/or detected.

“Software”, as used herein, includes but is not limited to, one or more executable instructions that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

In one example, a method may be implemented as computer executable instructions. Thus, in one example, a non-transitory computer-readable storage device may store computer executable instructions that if executed by a machine (e.g., processor) cause the machine to perform a method. While executable instructions associated with a method are described as being stored on a computer-readable storage device, it is to be appreciated that executable instructions associated with other example methods described herein may also be stored on a computer-readable storage device.

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the embodiments described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Throughout this specification and the claims that follow, unless the context requires otherwise, the words ‘comprise’ and ‘include’ and variations such as ‘comprising’ and ‘including’ will be understood to be terms of inclusion and not exclusion. For example, when such terms are used to refer to a stated integer or group of integers, such terms do not imply the exclusion of any other integer or group of integers.

What is claimed is:

1. A non-transitory computer-readable storage device storing instructions that when executed by a computer control the computer to perform a method, comprising:
capturing electronic information about a purchase of computer hardware or software;
detecting a registration associated with the purchase of the computer hardware or software, where the registration is initiated as part of an installation of the computer hardware or software; and
providing a customized automated installation process that provides a graphical linear experience through the installation of the computer hardware or software, where the graphical linear experience is presented on computer hardware other than computer hardware included in the purchase that is being installed, and where the customized automated installation process runs, at least in part, on a processor other than a processor included in the purchase that is being installed.

2. The non-transitory computer-readable storage device of claim 1, where capturing the electronic information includes receiving data from a point of sale device, receiving data from a server involved in the purchase, or receiving data from a website involved in the purchase.

3. The non-transitory computer-readable storage device of claim 1, where the electronic information includes an identifier of the computer hardware, an identifier of the computer software, an activation start time, an activation duration, an activation end time, or license details.

4. The non-transitory computer-readable storage device of claim 1, where detecting the registration includes receiving registration data from a server accessed during the registration or from a website accessed during the registration, and where the registration data includes user identity information, hardware identity information, software identity information, activation information, or license information.

5. The non-transitory computer-readable storage device of claim 1, where the graphical linear experience includes an ordered series of verifiable steps that are presented without branch points.

6. The non-transitory computer-readable storage device of claim 5, where members of the ordered series of verifiable steps are verified on a per step basis.

7. The non-transitory computer-readable storage device of claim 6, where the customized automated installation process maintains a log of the progress of the graphical linear experience on a per step basis.

8. The non-transitory computer-readable storage device of claim 1, where the customized automated installation process receives a photograph of at least a portion of the computer hardware and provides an annotated version of the photograph as part of the customized automated installation process.

9. The non-transitory computer-readable storage device of claim 1, where the customized automated installation process receives a photograph of at least a portion of the computer hardware and verifies ownership of the portion of the computer hardware based, at least in part, on a visual identifier in the photograph.

10. The non-transitory computer-readable storage device of claim 1, where the customized automated installation process provides real-time up-to-date installation information to a technical support organization associated with the computer hardware or software during the installation of the computer hardware or software, where the real-time up-to-date installation information includes cable connectivity information, network address verification information, communication verification information, or provisioning information.

11. The non-transitory computer-readable storage device of claim 10, where the real-time up-to-date installation information is provided on a step-by-step basis during the installation of the computer hardware or software.

12. The non-transitory computer-readable storage device of claim 1, where the customized automated installation process dynamically updates the graphical linear experience by selecting information to present at a subsequent step in the installation based, at least in part, on a result achieved at a previous step in the installation.

13. An apparatus, comprising:
a processor;
a memory that stores information about a purchase of computer hardware or software;
a set of circuits; and
an interface that connects the processor, the memory, and the set of circuits;
the set of circuits comprising:
a first circuit that captures electronic data about the purchase;
a second circuit that provides a customized presentation from a customized automated installation process, where the customized presentation is based, at least in part, on the electronic data; and
a third circuit that monitors the customized automated installation process.

14. The apparatus of claim 13, where the first circuit captures the electronic data about the purchase from a point of sale device, from a website involved in the purchase, or from a server involved in the purchase.

15. The apparatus of claim 14, where the electronic data about the purchase includes a hardware identifier, a software identifier, or license details including a license start time, a license stop time, a license duration, or a licensed number of users.

16. The apparatus of claim 13, where the customized presentation is a linear graphical presentation that includes no branch points discernible to the user.

17. The apparatus of claim 16, where the third circuit performs verification of the customized presentation at each step presented.

18. The apparatus of claim 17, where the third circuit selectively provides an electronic log of the verification of the customized presentation, where the electronic log includes cable connection information, electrical connectivity information, address provisioning information, or data communication information.

19. The apparatus of claim 13, where the apparatus is not part of the computer hardware, and where the customized automated installation process is not a part of the software.

20. An integrated circuit, comprising:
gates configured to identify a purchased item at a time when the item is purchased;
gates configured to identify a registration of the purchased item, where the registration occurs at a point in time after the purchase; and
gates configured to reconcile the purchased item and the registration and to produce an installation presentation specific to the purchased item.
